(19) United States
(12) Patent Application Publication
(10) Pub. No.: US 2025/0207866 A1
(43) Pub. Date: Jun. 26, 2025

(54) THERMAL ENERGY TRANSFER AND STORAGE SYSTEM TO GENERATE HIGH TEMPERATURE FLUIDS

(71) Applicant: NOC ENERGY, Houston, TX (US)

(72) Inventors: Carlos Alberto CEBALLOS CASTILLO, Medellín (CO); John Dairo RESTREPO GIRALDO, El Retiro (CO)

(21) Appl. No.: 18/986,956

(22) Filed: Dec. 19, 2024

Related U.S. Application Data
(60) Provisional application No. 63/612,904, filed on Dec. 20, 2023.

(51) Int. Cl. F28D 20/00; C09K 5/06; H05B 6/10; H05B 6/80; H05H 1/24

(52) U.S. Cl. CPC F28D 20/0056; C09K 5/063; H05B 6/108; H05B 6/802; F28D 2020/0065; H05H 1/24

(57) ABSTRACT

The present disclosure is related to a system for generating high-temperature fluids, designed to reduce carbon emissions and improve energy efficiency in various industrial processes. The system leverages advanced thermal energy transfer and storage technologies to efficiently utilize diverse energy sources, including grid electricity, renewable energy, and waste heat from industrial processes. Particularly, the system comprises a heating subsystem, a heat transfer and storage subsystem, a post-heating subsystem, and an electrical feeding subsystem, a fluid circulation subsystem and a cooling circulation subsystem. The heat transfer and storage subsystem utilize innovative materials and techniques to efficiently store and release thermal energy, enabling the system to operate with high thermal efficiency and flexibility.

The system can be integrated into various industrial processes, and by optimizing energy utilization and reducing reliance on fossil fuels, the system contributes to a more sustainable and environmentally friendly future. Additionally, the system can be integrated with different renewable electricity generation systems such a photovoltaic, wind, hydroelectric, among others. The system can also be integrated with the electrical grid, providing valuable grid services such as load balancing, energy shifting, and frequency regulation. This enhances grid stability and enables the system to contribute to a more resilient and efficient energy infrastructure.

Furthermore, this invention offers a promising solution for reducing carbon emissions, improving energy efficiency, and enhancing the flexibility and reliability of industrial processes.

### CROSS REFERENCE TO RELATED APPLICATIONS

This application claims priority from provisional patent application 63/612,904 filed on Dec. 20, 2023, which is incorporated herein by reference in its entirety.

### RELATED TECHNICAL FIELD

The present disclosure is related to a system to generate very high-temperature fluids to replace fuels partially or completely in various industrial processes, reducing carbon emissions to comply with industry's decarbonization objectives while optimizing the reduction of carbon emission, energy cost and energy availability, and generate additional benefits from grid services such as load balancing, energy shifting, energy storage, and frequency regulation amongst others.

Particularly, energy sources for the system include but are not limited to electricity from the grid, intermittent electricity from renewables, and waste heat from other industrial processes. Also, the system can be integrated into existing infrastructure, including but not limited to, boilers, dryers, ovens, blast furnaces, kilns, heat exchangers, chemical reactors, distillation equipment, cracking towers, gas reformers, gas turbines for power generation, etc.

In addition, high flexibility for the user is achieved by (i) using various energy sources, (ii) enabling integration into existing infrastructure, (iii) having the ability to operate alongside existing energy sources such as gas burners and, (iv) being able to achieve temperatures over 1000° C.

Other clear advantages are related to the ancillary services provided to the grid as it holds energy shifting capabilities to minimize energy curtailment and enabling arbitrage where markets allow it. Beyond its storage capabilities, if the system is coupled with a gas turbine, a turbo expander, or combined cycle plant, it provides essential benefits such as peaking power and energy, grid stability, offering services like inertia provision and frequency regulation. The system is a versatile and impactful tool within the broader strategy of achieving cleaner, more sustainable, and resilient energy systems, particularly addressing the pressing need for sustainable methods of producing industrial heat.

### BACKGROUND

The imperative to decarbonize industrial heat processes that are burning fossil fuels to obtain heat is driven by their significant role in greenhouse gas (GHG) emissions. These processes account for approximately one third of the global total GHG emissions and nearly 40% of fossil fuel consumption. Notably, industries posing the greatest challenges for emissions reduction, including cement, steel, glass, ceramics, and others, demand exceptionally high temperatures exceeding 1000° C., achievable at industrial scales mostly through the combustion of fuels.

Besides their significant contribution to GHG emissions, decarbonizing these processes is imperative for several reasons including (i) climate goals as many countries and industries have committed to ambitious climate goals, such as achieving net-zero emissions (ii) regulatory compliance as increasingly stringent environmental regulations and emissions standards demand the reduction of carbon emissions from industrial operations, (iii) resource efficiency as traditional industrial heat processes often involve inefficient energy conversion and utilization, leading to wastage of resources, (iv) market and consumer pressure due to a growing demand from consumers, investors, and markets for sustainable and environmentally friendly products, (v) technological advancements as there are several viable alternatives for decarbonizing industrial heat processes from renewable energy sources to innovative heat storage solutions, (vi) risk mitigation because industries that continue to rely on carbon-intensive heat processes face long-term risks related to the volatility of fossil fuel prices, and (vii) sustainable development as embracing decarbonization aligns with the principles of sustainable development, promoting economic growth while minimizing environmental and social impacts.

Currently industries have different options for decarbonizing their processes, for instance:
Replacing fuels for heating with renewable electricity.
Replacing fuels or feedstock with carbon neutral hydrogen, e.g., in ammonia production.
Replacing feedstock or fuel with sustainably produced biomass to reduce CO2 emissions, e.g., use of biobased feedstock in chemicals production.
Capturing the CO2 emitted and storing or using it e.g. carbon capture, use and storage (CCUS).

Hard to abate industries add more complexity because some of them use fuel as feedstock, are very energy intensive creating a scalability problem and require very high temperatures typically achieved only through combustion.

The rise of renewables has spurred initiatives to convert renewable electricity into heat, recognizing the need for storage due to the intermittent nature of many renewables. Various initiatives have emerged aiming at transforming renewable energy into industrial heat, yet these initiatives face numerous challenges. For instance, many systems rely on electrical resistors and joule effect to heat substantial masses of materials for thermal energy storage. However, these technologies encounter limitations, particularly on an industrial scale, wherein the maximum achievable temperature is confined to below 1000° C. to guarantee the lifetime of the resistors. Thus, the inherent limited temperature operation of these technologies is restricted by the heating method and not by the materials in which the energy is stored.

Although storage is required in cases where the energy source is intermittent renewables or there is variable intra-day pricing, in most areas of the world, this is not yet the case. There is, therefore, a need for direct conversion of electricity to high-temperature heat with the flexibility to add storage as needed and this is a new area that has not yet received full attention.

The state of the art discloses energy accumulators such as those disclosed in U.S. Ser. No. 10/254,050B2, U.S. Pat. No. 3,960,207A and document “TECHNOLOGY IN DESIGN OF HEAT EXCHANGERS FOR THERMAL ENERGY STORAGE”.

The document U.S. Ser. No. 10/254,050B2 discloses a thermal energy storage device with reduced internal natural convection comprising a casing, a thermal energy storage structure arranged within the casing, the thermal energy storage structure comprising thermal energy storage elements, the material of which is selected from brick, stone, lava stone, granite, basalt or ceramic, and a plurality of dividing elements.

In particular, the thermal energy storage elements of U.S. Ser. No. 10/254,050B2 are arranged in layers divided by dividing elements to form the thermal energy storage structure. The thermal storage elements are sized and spaced apart from each other such that each layer allows a flow of working fluid in a direction parallel to the layer of thermal energy storage elements.

Additionally, U.S. Ser. No. 10/254,050B2 discloses a convection reducing structure comprising at least one plate perforated to support a layer of convection reducing elements extending in a direction perpendicular to the layers of thermal storage elements.

The document U.S. Pat. No. 3,960,207A discloses a heat exchanger device comprising a plurality of hollow disc-shaped containers filled with a thermal energy storage material and disposed in a stacked array.

Also, U.S. Pat. No. 3,960,207A discloses that each of the containers features an orifice in the center which together form a conduit, and a plurality of orifices formed in the inner casing to allow air or other fluid (either gas or liquid) to flow from the annular chamber inward through the annular space between the containers, directing said fluid radially and inwardly through said orifices and then out of said apparatus.

On the other hand, the document “TECHNOLOGY IN DESIGN OF HEAT EXCHANGERS FOR THERMAL ENERGY STORAGE” describes a technology for the design of heat exchangers for thermal storage comprising a shell and tube heat exchanger, which consists of one or more round tubes mounted in a configuration parallel to a cylindrical casing.

In particular, the document “TECHNOLOGY IN DESIGN OF HEAT EXCHANGERS FOR THERMAL ENERGY STORAGE” discloses that said device exchanges heat which, through the walls of the pipes, between a heat transfer fluid flowing through the pipes and a phase change material contained in the casing. As the heat transfer fluid passes through the pipes, a phase change occurs in the phase change material during the charging or discharging process. At discharging process, solidification of the phase change material will begin at the pipe walls, thus acting as a thermal resistor.

Accordingly, the state of the art fails to disclose systems and apparatus for decarbonizing industrial heat processes that enable a fundamental shift towards more sustainable and responsible industrial practices essential for addressing climate change and ensuring a resilient and sustainable future.

### SUMMARY

The present disclosure is related to a system to generate very high-temperature fluids to replace fuels partially or completely in various industrial processes, reducing carbon emissions to comply with industry's decarbonization objectives while optimizing the reduction of carbon emission, energy cost and energy availability, and generate additional benefits from grid services such as load balancing, energy shifting, energy storage, and frequency regulation amongst others.

Particularly, the present disclosure describes a system for generation, storage and transfer of thermal energy, comprising a heating subsystem, a heat transfer and storage subsystem connected to the heating subsystem, a post heating subsystem connected to the heat transfer and storage subsystem, and an electrical feeding subsystem connected to the heating subsystem, the heat transfer and storage subsystem, and the post heating subsystem, wherein the heat transfer and storage subsystem and the post heating subsystem are configured to change the temperature of a fluid.

The present disclosure also describes an array for generation, storage and transfer of thermal energy, comprising a first system, a second system connected to the first system, wherein the outlet of a first heating subsystem of the first system is configured to be the inlet of the second system, wherein a set of heat transfer and storage elements of a heat transfer and storage subsystem of the first system transfers energy to a fluid to approach a target outlet temperature required by an industrial process.

In addition, if the temperature of the fluid in the first heating subsystem does not provide enough temperature to reach the target outlet temperature, an outlet of the first system is diverted by means of a diverter to a second heating subsystem of the second system, and wherein the fluid enters pre-heated by the heat transfer and storage subsystem of the first system to the second heating subsystem in such a way that the fluid is able to reach the target outlet temperature required by the industrial process.

### BRIEF DESCRIPTION OF THE DRAWINGS

FIG. 1 provides a schematic representation of the thermal energy transfer and storage system of the present disclosure.

FIG. 2 presents a schematic diagram of one embodiment of the thermal energy transfer and storage system of the present disclosure and its component elements.

FIG. 3 provides a visual representation of a specific embodiment of the system, highlighting the flow of a fluid through a set of heat transfer and storage elements.

FIG. 4 shows a schematic diagram of a structure which is part of a system designed for heat transfer or fluid processing described in the present disclosure. The structure contains some set of heat transfer and storage elements arranged in a specific configuration.

FIG. 5 presents a schematic diagram of an embodiment of the structure with internal components designed for specific applications.

FIG. 6 provide a schematic diagram of some embodiments of the system of the presents disclosure which is involved in a heating process. The system utilizes microwave energy to heat a set of heat transfer and storage elements.

FIG. 7 illustrates a versatile system capable of operating in both series and parallel configurations.

FIG. 8A, FIG. 8B, and FIG. 8C presents a schematic diagram of some embodiments of the system designed for industrial processes, capable of operating in both closed-loop and open-loop configurations.

### DETAILED DESCRIPTION

The present disclosure refers to systems that allow the heating of fluids. In particular, the present disclosure is related to systems that implement electromagnetic fields or electromagnetic radiation to increase the temperature of elements that interact with fluids, so that they increase their temperature.

Also, one objective of present disclosure is to provide processes requiring heat with thermal energy attained by means of converting electricity through electromagnetic fields, electromagnetic radiation, or both, into thermal energy. This thermal energy can be either immediately used or stored for later use. Also, the thermal energy is transported and made usable by means of high temperature fluids that can deliver the energy to both new or existing infrastructure. Additionally, the thermal energy can be converted back into electricity in certain applications.

Another objective of the present disclosure is to enable the storage of energy in the form of heat in cases wherein the electrical energy source is intermittent or vary its price throughout a short period of time in certain applications, enabling the provision of grid services such as inertia provision, frequency regulation, load shifting, peak shaving, arbitrage etc. Additionally, in certain markets and applications, enabling the recycling or re-utilization of waste heat to increase energy efficiency in certain applications.

Particularly, the present disclosure refers to a system to generate high temperature fluids that can be used with existing or new process infrastructure to replace heat produced by fuels and combustion systems with electricity from the grid or microgrid electrical sources like solar photovoltaic, wind energy or any other source of firm or intermittent electricity. The system can also integrate the recovery of waste heat sources from industrial processes.

The present disclosure describes a system (100) for generation, storage and transfer of thermal energy, comprising a heating subsystem (10), a heat transfer and storage subsystem (20) connected to the heating subsystem (10), a post heating subsystem (50) connected to the heat transfer and storage subsystem (20), and an electrical feeding subsystem (80) connected to the heating subsystem (10), the heat transfer and storage subsystem (20), and the post heating subsystem (50), wherein the heat transfer and storage subsystem (20) and the post heating subsystem (50) are configured to change the temperature of a fluid (1).

Particularly, the heat transfer and storage subsystem (20) comprises media that transfers and stores heat to and from the circulating fluid (1) by conduction, convection and radiation principles.

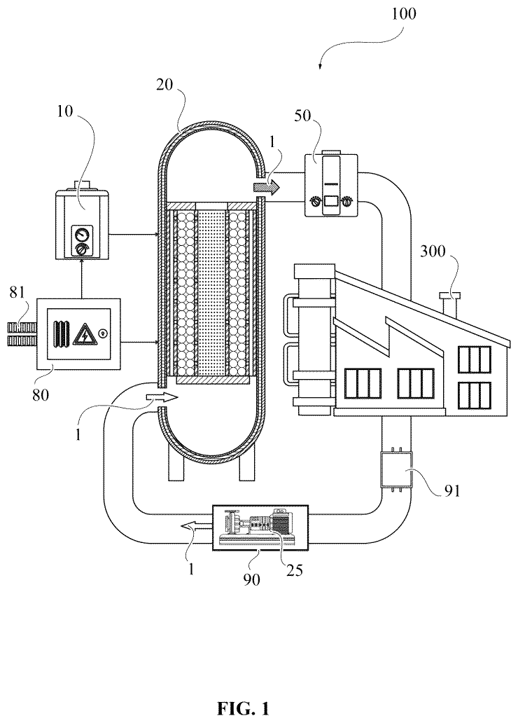

Referring to FIG. 1, in a first embodiment of the system (100), the fluid (1) is the medium through which thermal energy is transferred. The fluid (1) can be a liquid, e.g., water, oil, or gas, e.g., air or steam. The specific fluid (1) will depend on the desired temperature range and the specific application of the system (100).

In the herein disclosed system (100), the fluid (1) is circulated through heat transfer and storage subsystem (20). Such heat transfer and storage subsystem (20) is heated primarily by means of electromagnetic fields or electromagnetic radiation.

In some embodiments of the system (100), the fluid (1) is a radiant gas which comprises molecules with polar bonds and/or permanent dipole moments such as H₂O or CO₂, molecules with multiple bonds such as C═O or N≡N, wherein the multiple bonds can be double or triple bonds, polyatomic molecules with a wide range of vibrational and rotational modes such as CH₄ and N₂O, molecules with resonance structures, where electrons are delocalized across multiple atoms such as O₃, and heavy atoms with strong bonds such as SO₂.

Molecules with polar bonds or permanent dipole moments, such as H₂O and CO₂, can align with the oscillating electric field of the microwave radiation, leading to efficient energy absorption. Also, molecules with multiple bonds, such as CO and N₂, can undergo vibrational and rotational transitions, absorbing microwave energy and converting it into thermal energy.

An advantage of the above is that molecules with polar bonds or permanent dipole moments (e.g., H₂O and CO₂) interact strongly with oscillating electromagnetic fields or electromagnetic radiation, which leads to efficient energy absorption and heating. Molecules with multiple bonds (e.g., C═0, N≡N) exhibit a variety of vibrational and rotational transitions, which allow for effective absorption of radiant energy, which is quickly converted into thermal energy, enhancing heat transfer. Also, polyatomic molecules (e.g., CH₄ and N₂O) have a wide range of vibrational and rotational modes, allowing them to absorb energy across multiple frequencies, increasing overall heating efficiency. Particularly, molecules with resonance structures (e.g., O₃) have delocalized electrons that enable additional pathways for energy absorption and redistribution, promoting uniform heat distribution. Also, molecules with heavy atoms and strong bonds (e.g., SO₂) can absorb and store significant amounts of energy, making them effective for high-temperature applications. On the other hand, radiant gases naturally emit thermal radiation after absorbing energy, which facilitates efficient transfer of heat through radiation in systems designed for radiant energy propagation. Therefore, the combination of polar bonds, multiple bonds, and resonance structures allows radiant gases to be tailored for specific applications, from industrial heating to energy-efficient thermal management systems.

Also, the fluid (1) may be compressible or incompressible, and can be oxidizing, reducing or inert depending on an industrial process needs.

On the other hand, the energy source to which the heating subsystem (10) is connected can be selected from a list of energy sources such as electricity in the form of direct current or alternating current, at any voltage level and in any frequency, as the heating subsystem (10) operation can be frequency and voltage independent. The electricity source can be firm power, like when it comes from the grid, or intermittent power, like when it comes from renewables such as for instance, solar photovoltaic or wind. In one embodiment of the system (100), other source of energy to heat the heat transfer and storage subsystem (20) may be waste heat from other processes in the form of a hot fluid.

In another embodiment of the system (100), the heating subsystem (10) converts electricity into heat that will heat the fluid by means of electromagnetic fields or electromagnetic radiation, converts ionizing radiation into heat, recovers waste heat, or performs a combination of the above.

In any of the embodiments of the system (100), the heat transfer and storage subsystem (20) comprises a heat exchanger apparatus (21), wherein said heat exchanger apparatus (21) comprises a structure (22) with an inlet (22A) and an outlet (22B), and wherein the structure (22) has a longitudinal axis. The structure (22) serves as a conduit or channel for the fluid (1), the inlet (22A) is the point of entry for the fluid (1) into the structure (22), it may be a port, opening, or connection point designed to receive the incoming fluid (1). The outlet (22B) is the point of exit for the fluid (1) from the structure (22), and as the inlet (22A), the outlet (22B) may be a port, opening, or connection point designed to release the outgoing fluid (1).

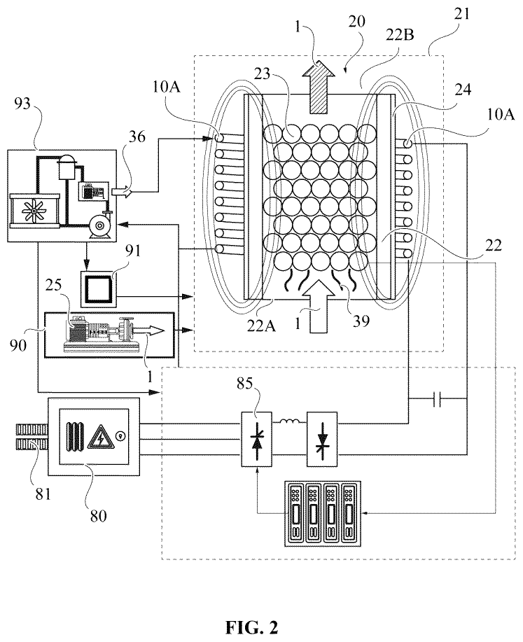

Also, in one embodiment of the system (100) and referring to FIG. 2, the heat exchanger apparatus (21) comprises a structure (22) comprising an inlet (22A) and an outlet (22B), a set of heat transfer and storage elements (23) disposed inside the structure (22), an insulation subsystem (24) covering the structure (22) and configured to minimize heat losses to the surrounding environment, and a driving device (25) connected to the structure (22) and configured to generate the displacement of the fluid (1) inside the structure (22), wherein the fluid (1) interacts with the set of heat transfer and storage elements (23), and wherein the heat exchanger apparatus (21) is configured to allow the passage of the fluid (1) from the inlet (22A) to the outlet (22B) and vice versa, wherein the temperature of the heat transfer and storage elements (23) is different from the temperature of the fluid (1).

In one embodiment of the system (100), the energy supplied by the heating subsystem (10) heats up the set of heat transfer and storage elements (23) and a heat flux (39) (not illustrated) transports the energy to the fluid (1), wherein the energy supplied is stored in the set of heat transfer and storage elements (23) for immediate or later use, wherein a closed energy balance between the energy input from the heating subsystem (10), the energy stored in the set of heat transfer and storage elements (23) and the energy absorbed by the fluid (1) leaving the system (100) and the system (100) energy losses is generated.

The system (100) is designed to efficiently manage and utilize thermal energy, and an important aspect of the system (100) is the energy balance, which ensures that the energy input from the heating subsystem (10) is effectively distributed between the heat transfer and storage elements (23) and the fluid (1). Also, the system (100) aims to maintain a closed energy balance, meaning that the energy input from the heating subsystem (10) equals the sum of the energy stored in the heat transfer and storage elements (23), the energy absorbed by the fluid (1), and the energy losses.

The heat flux (39) represents the rate of heat transfer between the fluid (1) and the heat transfer and storage elements (23). Said heat flux (39) is influenced by factors such as the temperature difference between the fluid (1) and the heat transfer and storage elements (23), the surface area of the heat transfer and storage elements (23), and the thermal conductivity of the materials involved.

A larger temperature difference between the fluid (1) and the elements (23) results in a higher heat flux (39), this is because a greater temperature difference drives a stronger thermal gradient, leading to increased heat transfer, and the thermal conductivity of the materials involved in the heat transfer process, e.g. the materials from which the set of heat transfer and storage elements (23) is made, affects the rate at which heat is conducted through the materials. Particularly, higher thermal conductivity materials facilitate faster heat transfer.

The fluid (1) entering the system (100), moved by, for instance, the driving device (25), e.g., a fan, a compressor, a pump, or any other suitable device for moving fluids, interacts with the set of heat transfer and storage elements (23) inside the structure (22) that are at a different temperature than the fluid (1). The system (100) is configured to allow the passage of the fluid (1) from the inlet (22A) to the outlet (22B) and vice versa.

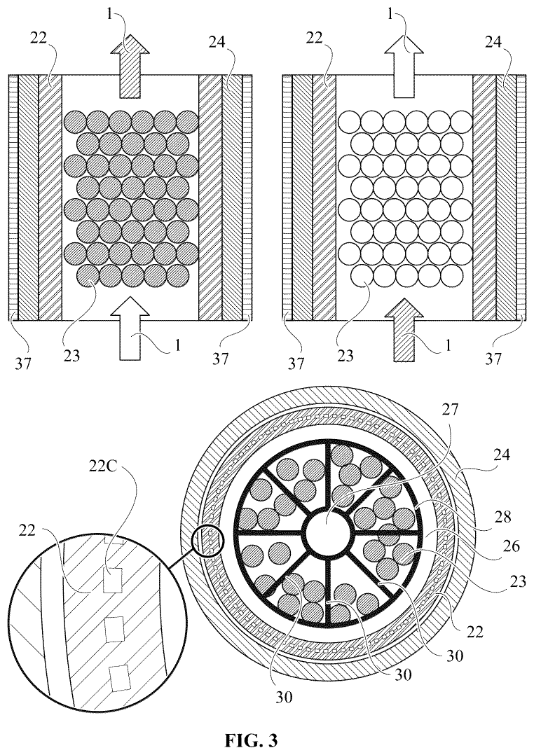

Referring to FIG. 3, one purpose of the set of heat transfer and storage elements (23) is transferring thermal energy from the heating subsystem (10) to the fluid (1), storing thermal energy from the heating subsystem (10) or from a previously circulated hot fluid or a combination thereof.

The set of heat transfer and storage elements (23) may be for example, particles, fibers, three-dimensional geometric elements, open or closed cell foams or porous materials with random or pseudo-periodic pore structures, triple periodic minimal surfaces (TPMS) for example Gyrod surfaces, Schwarz P surfaces, Schwarz D surfaces, Fischer-Koch S surfacs, Lattice-Based Cellular Structures or any other TPMS, a mesh, or any other configuration that allows the fluid (1) to flow through them or through an array of them. The flexibility of the set of elements (23) in terms of configuration and material allows the system (100) to be adapted to a wide range of applications and operating conditions, for example, an advantage of using porous materials as the set of heat transfer and storage elements (23) is that such porous materials or structures allow to increase the contact area between the fluid (1) and the set of heat transfer and storage elements (23), this facilitates heat transfer, since a larger contact area allows a greater exchange of thermal energy, and by increasing the heat transfer, the efficiency of the system (100) is improved, since a greater proportion of the generated heat is used. At the same time, the materials or structures of the set of heat transfer and storage elements (23) minimize the pressure drop increasing the efficiency of the system.

In any of the embodiments of the system (100), the set of heat transfer and storage elements (23) is configured to increase its temperature due to the action of the heating subsystem (10).

In one embodiment, the system (100) may be part of an array (400) including at least one system (100) which may work as direct heating of the fluid (1) or as thermal storage. The capability of the system (100) to operate as a direct heating system or as thermal storage provides flexibility in its use, e.g., when an immediate heat source is required, the system (100) can operate in direct heating mode, transferring heat directly to the fluid (1) or when excess energy is available, e.g., during periods of low demand, the system (100) can operate as thermal storage, storing energy for later use.

Also, in any of the embodiments of the system (100), the set of heat transfer and storage elements (23) may be made of conductive materials, which means that said set of heat transfer and storage elements (23) are made of materials that can transport energy, either in the form of heat or electricity or both.

Referring to FIG. 3, in one of the embodiments of the system (100), the fluid (1) flows through the set of heat transfer and storage elements (23) and parallel to the axis of the structure (22). Parallel flow allows for continuous and efficient heat exchange between the fluid (1) and the heat transfer and storage elements (23).

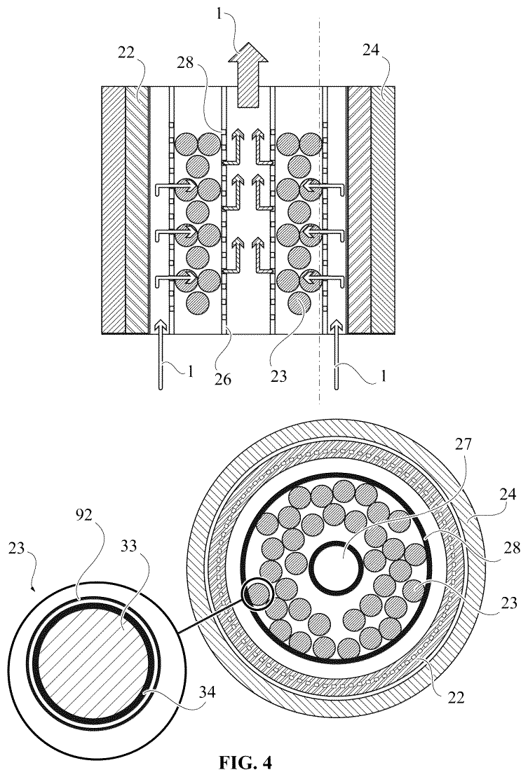

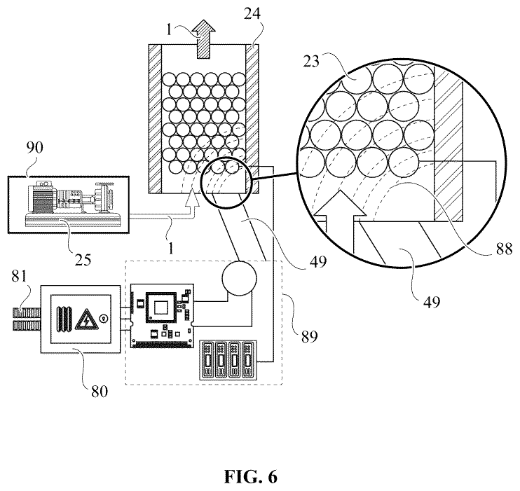

Referring to FIG. 4 and FIG. 6 in another embodiment of the system (100), the fluid (1) flows through the set of heat transfer and storage elements (23) and non-parallel to the axis of the structure (22). The non-parallel flow pattern allows for greater contact between the fluid (1) and the heat transfer and storage elements (23), this increased contact area results in more efficient heat transfer, as the fluid (1) can interact with a larger surface area of the set of heat transfer and storage elements (23) and can help to ensure a more uniform temperature distribution within the fluid (1), as the fluid (1) is exposed to the set of heat transfer and storage elements (23) from multiple angles without increasing the pressure drop.

The materials from which the set of heat transfer and storage elements (23) may be made are selected from the group that includes carbon steel, silicon steels, tungsten disilicide, nickel-based superalloys, cast iron, galvanized iron, chromium steels, chromium-nickel steels, chromium-nickel-titanium steels, nickel-chromium-molybdenum-tungsten alloys, ferrous alloys with chromium-molybdenum, stainless steel 301, stainless steel 302, stainless steel 304, stainless steel 316, stainless steel 405, stainless steel 410, stainless steel 430, stainless steel 442, manganese alloyed steel, cobalt alloys, graphite, silicon carbide, silicon-infiltrated silicon carbide, aluminum oxide, zirconium, tungsten, titanium, cermets, high temperature ceramics, refractory mortars, refractory tiles or bricks, super high curie point materials such as the perovskite-like layer structured (PLS) A2B2O7 materials, composite materials made of organic or inorganic resins with or without organic or inorganic fibers reinforcement, lead, depleted uranium, or other materials known to a person of ordinary skill in the art, or a combination thereof, as a solid element, a hollow element or as a multilayered element.

Referring to FIG. 2, FIG. 3, FIG. 4, and FIG. 6, the form of the set of heat transfer and storage elements (23) can be selected from spherical shape, pyramids, cones, disks, prisms, cubes, spheres, parallelepipeds, cylinders, hyperboloids, pearls, or any other three-dimensional shape. In one embodiment of the system (100), the set of heat transfer and storage elements (23) are spheres.

Referring to FIG. 4, in one embodiment of the system, the set of heat transfer and storage elements (23) can be made of at least two materials, an inner material correspond to a core layer (33) and may be a material with a phase change temperature lower than a shell layer which corresponds to an outer layer (34), wherein the outer layer (34) covers the core layer (33). For example, when the core layer (33) is heated and melted, the outer layer (34) having a higher melting temperature, remains in a solid state, which allows the molten core layer (33) to be encapsulated.

The main advantage of a core-shell configuration, in which the core layer (33) is a phase change material is that it increases the density of the energy that can be stored by absorbing latent and sensible heat. Another advantage is that the outer layer (34) electrically insulates the core layer (33), for example, when there is more than one core layer (33), this insulation ensures each core layer (33) independently generates localized eddy currents when exposed to an electromagnetic field, resulting in a more effective conversion of electromagnetic energy into heat. Consequently, this core-shell configuration improves the susceptibility of the system (100) for heating through electromagnetic fields and waves, leading to improved efficiency of the system (100).

The materials from which the core layer (33) may be made are selected from the group consisting of carbon steel, silicon steels, nickel-based superalloys, cast iron, galvanized iron, chromium steels, chromium-nickel steels, chromium-nickel-titanium steels, nickel-chromium-molybdenum-tungsten alloys, ferrous alloys with chromium-molybdenum, stainless steel 301, stainless steel 302, stainless steel 304, stainless steel 316, stainless steel 405, stainless steel 410, stainless steel 430, stainless steel 442, manganese alloyed steel, cobalt alloys, graphite, silicon carbide, silicon-infiltrated silicon carbide, aluminum oxide, zirconium, tungsten, titanium, cermets, high temperature ceramics, refractory mortars, refractory tiles or bricks, super high curie point materials such as the perovskite-like layer structured (PLS) A2B2O7 materials, lead, depleted uranium, depleted uranium, titanium, lead, tungsten, paraffin, eutectic salts, lithium compounds, or any other similar material known to a person of ordinary skill in the art, or a combination thereof.

The materials from which the outer layer (34) may be made are selected from the group consisting of carbon steel, silicon steels, nickel-based superalloys, cast iron, galvanized iron, chromium steels, chromium-nickel steels, chromium-nickel-titanium steels, nickel-chromium-molybdenum-tungsten alloys, ferrous alloys with chromium-molybdenum, stainless steel 301, stainless steel 302, stainless steel 304, stainless steel 316, stainless steel 405, stainless steel 410, stainless steel 430, stainless steel 442, manganese alloyed steel, cobalt alloys, graphite, silicon carbide, silicon-infiltrated silicon carbide, aluminum oxide, zirconium, tungsten, titanium, cermets, high temperature ceramics, refractory mortars, refractory tiles or bricks, super high curie point materials such as the perovskite-like layer structured (PLS) A2B2O7 materials, lead, depleted uranium, titanium, lead, tungsten, or any other similar material known to a person of ordinary skill in the art, or a combination thereof.

In another embodiment of the system (100), the set of heat transfer and storage elements (23) may be small particles suspended in the fluid (1), for instance, in a slurry or in a gas suspended particles. One advantage of the above is that the large number of small particles provides a significantly increased surface area for heat exchange, facilitating rapid heat transfer between the fluid (1) and the small particles. Also, the small particles may be made of materials with high thermal conductivity, further enhancing heat transfer efficiency, and the properties of the suspension, such as particle size and concentration of the small particles may be dynamically adjusted to optimize the performance of the system (100). In addition, the dynamic mixing in a fluidized bed prevents localized overheating, fluidization leads to consistent thermal properties throughout the heating system (100) and allowing for a lower pressure drop due to the dynamic nature of the particle suspension. This can reduce energy costs associated with fluid circulation.

In addition, the system (100) allows an energy balance, meaning that energy input from the heating subsystem (10) is equal to the energy absorbed by the fluid (1) and any energy losses within the system. This can also mean that the energy input from the heating subsystem (10) is equal to the energy absorbed by the fluid (1), the energy stored in the set of heat transfer and storage elements (23) and the energy loses within the system (100). This balance allows efficient operation of the system (100) and prevents energy wastage. As the set of heat transfer and storage elements (23) absorb heat, its temperature rises. This temperature increase is essential for energy storage and subsequent efficient release to the fluid. Also, the absorbed energy may be stored within the set of heat transfer and storage elements (23), either as sensible heat (increased temperature) or latent heat (phase change).

In one embodiment of the system (100) described herein, the set of heat transfer and storage elements (23) increase its temperature by the heating subsystem (10), to a higher temperature than the fluid (1), with a temperature gradient sufficiently high to transport the heat flux (39) to the fluid (1). Thereby transferring energy to the fluid (1) as it passes through the set of heat transfer and storage elements (23) making the fluid (1) raise its temperature.

Said set of heat transfer and storage elements (23) is configured to increase its temperature by action of the heating subsystem (10) which allows increasing the temperature of the fluid (1) entering the inlet (22A) of the structure (22). For example, referring to FIG. 2 when the set of heat transfer and storage elements (23) are inside the structure (22), when the fluid (1) which is cold passes through the inlet (22A) of the structure (22), said cold fluid (1) interacts directly with the set of heat transfer and storage elements (23) which have a higher temperature compared to said cold fluid (1), which allows increasing the temperature of said fluid (1) thus allowing the fluid (1) heated to exit at the outlet (22B) of the structure (22).

In one embodiment, the system (100) can be configured in two modes. In the first mode, the energy supplied by the heating subsystem (10) heats the set of heat transfer and storage elements (23) and the heat flux (39) transports the energy to the fluid (1), that is, there is a closed energy balance between the energy input from the heating subsystem (10), the energy absorbed by the fluid (1) leaving the system (100) and the system (100) energy losses, and is referred to as direct heating method. If the energy supplied by the heating subsystem (10) is higher than the energy leaving the system (100) plus the energy loses, the difference can be stored in the set of heat transfer and storage elements (23). This is referred as charging as discharging method.

In the second mode, the energy supplied by the heating subsystem (10) heats the set of heat transfer and storage elements (23) and when it reaches its target operating temperature, the heating subsystem (10) may be shutdown. In this second mode, the energy supplied is stored in the set of heat transfer and storage elements (23) for immediate or later use and is referred to as thermal energy storage. The main difference between first and second mode is that, in second mode the heating subsystem (10) is not supplying more energy into the system (100), thus there is a closed energy balance between the energy stored in the set of heat transfer and storage elements (23) and the energy absorbed by the fluid (1) leaving the system (100) and the system (100) energy losses.

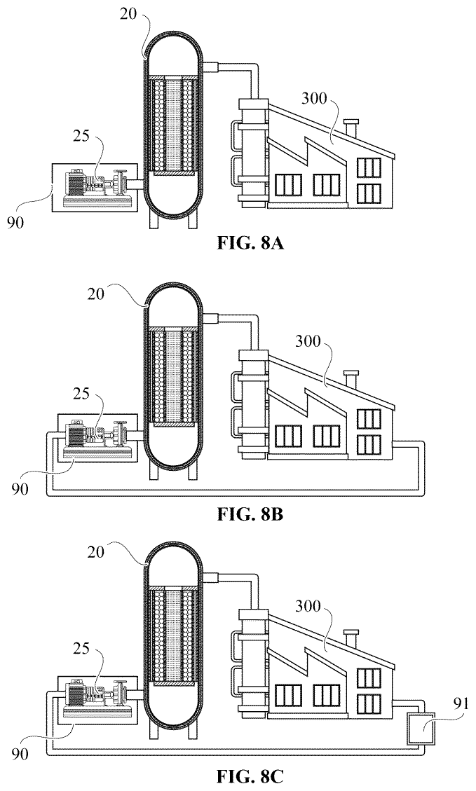

In another embodiment, the energy from the fluid (1) can be transferred to the set of heat transfer and storage elements (23). In this case, the set of heat transfer and storage elements (23) are colder than the fluid (1), and it increases its temperature as the fluid (1) passes through them, thereby taking energy from the fluid (1) and storing the energy in the set of heat transfer and storage elements (23). One application to this case is the regeneration or recovery of waste heat from an industrial process (300) as in FIG. 8B and FIG. 8C.

Additionally, in any of the embodiments of the system (100), the heating subsystem (10) can be cooled through a cooling fluid (36).

The cooling fluid (36) is a substance used to absorb and transfer heat away from the heating subsystem (10) and the post-heating subsystem (50). The cooling fluid (36) allows the system (100) to maintain optimum operating temperatures and prevent overheating of system (100) components. Additionally, the cooling fluid (36) may be at a significantly lower temperature than the set of heat transfer and storage elements (23) and the fluid (1).

One of the advantages related to the cooling fluid (36) is that the heat removed by the said cooling fluid (36) can be transferred to the fluid (1) through a heat exchanger recuperator (91).

Said heat exchanger recuperator (91) may be a device designed to recover waste heat from the cooling fluid (36) and transfer it to the fluid (1). Including said heat exchanger recuperator (91) to the process improves significantly the overall energy efficiency of the system (100), and by recovering waste heat, the system (100) can reduce energy consumption and operating costs.

Referring to FIG. 3, the structure (22) may be a refractory lined vessel or duct that is filled with a set of heat transfer and storage elements (23). Also, said structure (22) can comprise an insulation subsystem (24) to minimize heat losses to the surrounding environment. The structure (22) allows the fluid (1) to be compressed by increasing the energy that said fluid (1) can transport per unit volume. By reducing the size of the structure (22) per unit energy and reducing the speed of the fluid (1), a lower pressure drop is achieved.

The structure (22) may be designed to transport something from one place to another such as, for example, the fluid (1). Said structure (22) may have different shapes, sizes and purposes depending on its specific application. For example, the structure (22) may be straight or have different bends and elbows. Furthermore, the structure (22) has an inlet (22A) through which the fluid (1) enters, which may be a gas or a fluid in liquid state, and an outlet (22B) through which the fluid exits. According to the foregoing, the fluid (1) at the inlet (22A) of the structure (22) has an initial temperature, and when the fluid (1) is at the outlet (22B) of the structure (22), said fluid (1) has a final temperature, wherein the initial temperature of the fluid (1) is different from the final temperature.

Further, the structure (22) comprises at least one wall (22C) having an internal surface through which the fluid (1) flows, and an external surface which is covered by the insulation subsystem (24). In any other embodiment, the structure (22) may comprise more than one wall (22C), and at least one wall (22C) may be formed by a reticulated structure, a lattice structure, a lattice-reinforced, or a truss-reinforced double wall to increase its mechanical strength without increasing its weight, and for increasing the resistance of the structure (22) when it is subjected to high pressures, and also for improving the thermal insulation of the transfer and storage subsystem (20).

On the other hand, the structure (22) may be made of an energy-conducting material, e.g., the structure (22) is made of a material that has the capacity to transport energy, either in the form of heat or electricity, electromagnetic fields or a combination thereof.

The structure (22) is selected from the group which includes vessels, ducts, conduits, containers, tubes, channels, and pipes configured to support gage pressures between 0.1 bar and 30 bar.

Referring to FIG. 3, in one embodiment of the system (100), the structure (22) comprises an inner space and said inner space comprises a plurality of partitions (30) along the axial axis of the structure (22) configured to increase the surface area of the structure (22). In said plurality of partitions (30) are located the heat transfer and storage elements (23).

The plurality of partitions (30) allows a better transfer of energy from the electromagnetic field source or electromagnetic wave source to the set of heat transfer and storage elements (23). Referring to FIG. 3, the plurality of partitions (30) may be straight or have any other geometry.

In another embodiment of the system (100), the structure (22) may comprise a helicoidal duct to increase the surface area exposed to electromagnetic fields or electromagnetic radiation. The different layers of the helicoid are electrically insulated between them. By providing a larger surface area, there is a lower electrical resistivity and an increased magnetic permeability, allowing for a more efficient energy transfer from the heating subsystem (10) to the set of heat transfer and storage elements (23).

In one embodiment of the system (100), the structure (22) and the partitions (30) may be made of several layers, therefore increasing the surface area exposed to the electromagnetic field or electromagnetic radiation. The different layers are electrically insulated between them. By providing a larger surface area, there is a lower electrical resistivity and an increased magnetic permeability, allowing for a more efficient energy transfer from the heating subsystem (10) to the set of heat transfer and storage elements (23). Additionally, increasing the surface area increases the ability of the system (100) to transfer heat by convection and radiation thus increasing the efficiency of the heat transfer.

Referring to FIG. 6, in another particular embodiment of the system (100), the set of heat transfer and storage elements (23) may be a fluidized bed of particles made of materials that can be heated through electromagnetic fields or electromagnetic waves. One advantage of the above is that various materials can be used for the particles, such as metals, ceramics, or even composites, selecting those with the most suitable thermal and electromagnetic properties for a specific application, and that the use of electromagnetic fields or electromagnetic waves to heat the particles allows uniform and controlled heating.

Additionally, in another embodiment of the system (100), the set of heat transfer and storage elements (23) may be heated through the Joule effect. One advantage of the above is that by leveraging Joule heating, electrical energy is directly converted into heat within the set of heat transfer and storage elements (23), minimizing energy losses.

In another embodiment of the system (100), the set of heat transfer and storage elements (23) may be heated through radiant or convective heat or a combination thereof. Radiant heating directly transfers energy from the heat source to the set of heat transfer and storage elements (23), minimizing energy losses, and radiant heating may provide uniform heating of the set of heat transfer and storage elements (23), ensuring consistent performance. Also, convective heating may be a highly efficient method for transferring large amounts of heat to the set of heat transfer and storage elements (23). Another advantage of the above is that this allows a hot fluid (1) that can be radiant or not, to transfer its energy to the heat transfer and storage elements (23) efficiently for applications such as waste heat recovery.

Referring to FIG. 1. The heat transfer and storage elements (23) may also be heated through electromagnetic fields created by induction heating, wherein the frequency and shape of the electromagnetic field are tuned for increasing the electromagnetic coupling with the set of heat transfer and storage elements (23) and a skin depth required to achieve maximum energy transfer efficiency, wherein the heat transfer and storage elements (23) are heated through induced eddy and other currents by hysteretic heating or a combination thereof. The above allows the system (100) precise control and efficiency of the heating process, and by tuning the frequency and shape of the electromagnetic field it allows a much more efficient energy transfer process to be achieved, minimizing energy losses and maximizing the use of electrical energy.

Referring to FIG. 2, and in one embodiment of the system (100), induction heating is used as the heating energy source to heat the fluid (1). Induction heating is a process that heats an electrically conductive material, by generating electric currents inside the material that then dissipate as heat. The material to be heated is placed in an electromagnetic field created by a circulating current in an induction coil (10A) that is in proximity to said material. A rectifier is used to convert AC into DC which in turn is converted back to high-frequency AC by means of an electronic oscillator, making the coil produce an alternating magnetic field. The magnetic field induces eddy currents and/or other currents in the material which causes it to heat up without making contact with the induction coil (10A). The material, in this case, the set of heat transfer and storage elements (23) can be heated through the induced eddy currents, that when facing electrical resistance, heat the material via the Joule Effect. Additionally, in some cases, the magnetic domains of the set of heat transfer and storage elements (23) align with the applied magnetic field. The continuous reversal of the field (due to its alternating nature) causes energy loss as the domains realigns, which dissipates as heat. According to the above, and the embodiment of FIG. 2, the coil (10A) is located around the structure (22). In some cases, the structure (22) can also be heated using this method. The structure (22) then transfers the energy to the set of heat transfer and storage elements (23) via convective, conductive and radiative mechanisms.

In any of the embodiments of the system (100), the source of the electromagnetic field and its components can be cooled through the cooling fluid (36) and does not enter in contact with the heat transfer and storage elements (23) or the fluid (1) to be heated. This allows the electromagnetic heating energy source to be at a significantly lower temperature than the set of heat transfer and storage elements (23) and therefore the fluid (1) to be heated. The induction coil (10A) can have a channel through which said cooling fluid (36) passes, and the cooling fluid (36) can be circulated through the channel using a pump or other suitable means, ensuring adequate heat dissipation. By incorporating this cooling mechanism, the induction coil (10A) can operate reliably and efficiently, even under demanding conditions.

Referring to FIG. 6, the heat transfer and storage elements (23) may be heated by means of electromagnetic radiation created by microwave heating, wherein said microwave heating are produced by a microwave device (89). The frequency of the microwaves generated by the microwave device (89) may be tuned to match the resonant frequency of the set of heat transfer and storage elements (23), so that the energy is transferred efficiently to increase the kinetic energy of the molecules. The frequency of the microwaves is varied and tuned to exploit modulation to direct the energy and achieve better heating, uniformity and speed, wherein the heat transfer and storage elements (23) are heated by means of dipolar rotation, ionic conduction, absorption of radiation, among other methods of electromagnetic radiation.

Microwaves may be used as a heat source for the system (100). Microwave heating is another method used involving electromagnetic waves, as any material that is exposed to electromagnetic radiation can be heated up e.g., the set of heat transfer and storage elements (23). Also, microwaves are high-frequency electromagnetic waves that cause molecules to vibrate, generate heat through friction, and can be generated by vacuum tubes such as the klystron, magnetron, and Gunn diode or any other method known to a person of ordinary skill in the art.

In the system (100), the frequency of the microwaves may be tuned to match the resonant frequency of the material to be heated, e.g., the set of heat transfer and storage elements (23), so that the energy is transferred efficiently to increase the kinetic energy of the molecules. In addition, microwaves can also be generated using solid-state elements using wide bandgap semiconductors, such as gallium nitride. The above adds to the system (100) the ability to vary the frequency and exploit modulation to direct the energy and achieve better heating, uniformity and speed of the fluid (1).

Particularly, changing the operating frequency of the microwave device (89) has two major effects. The first effect is that it changes the coupling of the microwave energy to the material from which the set of heat transfer and storage elements (23) is made. Finding the frequency of optimal coupling allows obtaining maximum energy transfer to the material.

Referring to FIG. 6, the second effect is that by changing the operating frequency of the microwave device (89) some hot and cold spots in an applicator (49) move around.

Hot and cold spots are regions within a material that experience uneven heating when exposed to microwave radiation. These variations in temperature can be caused by factors such as the material's properties, the geometry of the object, and the specific configuration of the microwave field. Also, the hot and cold spots refer to areas within the set of heat transfer and storage elements (23) that experience different levels of heating when exposed to microwave radiation.

On the other hand, the microwave device (89) generates microwave energy, which is then transmitted to the applicator (49), which may be designed to distribute the microwave energy across the heat transfer and storage elements (23). Additionally, the applicator (49) may be a device designed to distribute microwave energy efficiently and evenly to the heat transfer and storage elements (23) and allows mitigating the formation of hot and cold spots and ensuring uniform heating.

Also, sweeping through the frequency range and moving the hot and cold spots effectively acts as a method to improve the uniformity of heating the set of heat transfer and storage elements (23). The set of heat transfer and storage elements (23) may be heated by means of dipolar rotation, ionic conduction, and absorption of radiation, among other similar methods known to a person of ordinary skill in the art.

Again, referring to FIG. 4, in one embodiment of the system (100), the microwave device (89) and its components can be cooled through the cooling fluid (36) and does not enter in contact with the set of heat transfer and storage elements (23) or the fluid (1) to be heated. The above allows the heating energy source to be at a significantly lower temperature than the set of heat transfer and storage elements (23) and therefore the fluid (1) to be heated.

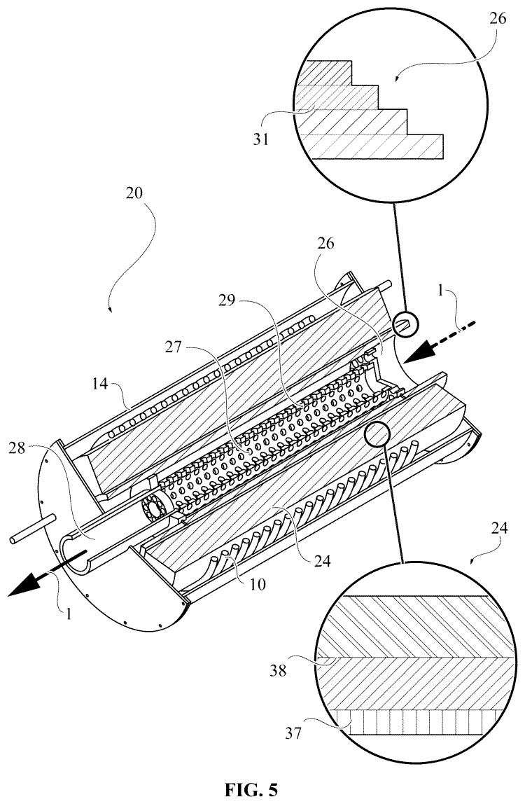

Referring to FIG. 4 and FIG. 5, in another embodiment of the system (100), the fluid (1) flows through the heat transfer and storage elements (23) and nonparallel (radial flow) to the axis of the structure (22). In this configuration of the system (100), the structure (22) further comprises an outer duct (26) configured for conducting and containing the fluid (1), an inner duct (27) disposed inside the outer duct (26) and configured for collecting and conducting the fluid (1) after it has been in contact with the set of heat transfer and storage elements (23), and an intermediate duct (28) disposed between the outer duct (26) and the inner duct (27) and configured for forcing the pass of the fluid (1) from the outer duct (26) to the inner duct (27), wherein the inner duct (27) and the intermediate duct (28) contain a plurality of openings (29) through which the fluid (1) flows. One of the advantages of this configuration is to reduce the pressure drop of the fluid (1) as it flows through the system (100).

Referring to FIG. 5, in a particular embodiment of the system (100), the structure (22), the outer duct (26), the inner duct (27), the intermediate duct (28), and the partitions (30) are made of several layers (31), wherein some layers (31) (not illustrated) are configured for increasing the surface area exposed to electromagnetic field or electromagnetic waves or conductive or radiant heat.

The materials from which the structure (22), the outer duct (26), the inner duct (27), the intermediate duct (28) and the partitions (30) can be made are selected from the group consisting of carbon steel, silicon steels, nickel-based super alloys, cast iron, galvanized iron, chromium steels, chromium-nickel steels, chromium-nickel-titanium steels, nickel-chromium-molybdenum-tungsten alloys, ferrous alloys with chromium-molybdenum, stainless steel 301, stainless steel 302, stainless steel 304, stainless steel 316, stainless steel 405, stainless steel 410, stainless steel 430, stainless steel 442, manganese alloyed steel, cobalt alloys, graphite, silicon carbide, silicon infiltrated silicon carbide, aluminum oxide, tungsten, titanium, cermets, high temperature ceramics, refractory mortars, refractory tiles or bricks, super high curie point piezo electric materials such as the perovskite-like layer structured (PLS) A2B2O7 materials, composite materials made of organic or inorganic resins with or without organic or inorganic fibers, or other materials known to a person of ordinary skill in the art, or a combination thereof.

In another embodiment of the system (100), and according to the upper left embodiment of FIG. 3, the set of heat transfer and storage elements (23) is configured to increase its temperature due to the action of hot fluid, wherein the energy of the hot fluid is transferred to the set of heat transfer and storage elements (23), wherein the set of heat transfer and storage elements (23) are colder than the hot fluid, and the set of heat transfer and storage elements (23) increases its temperature as the hot fluid passes through it, and wherein the energy of the hot fluid is absorbed and stored by the set of heat transfer and storage elements (23).

Particularly, due to the temperature difference between the hot fluid and the colder set of heat transfer and storage elements (23), heat is transferred from the hot fluid to the set of heat transfer and storage elements (23), and this heat transfer can occur through various mechanisms, such as conduction, convection, or radiation. Also, the heat absorbed by the set of heat transfer and storage elements (23) is stored within their material structure, and this can be achieved through sensible heat storage, latent heat storage, or a combination of both. This configuration contributes to the overall efficiency and flexibility of the system (100).

In another embodiment of the system (100), the outer surface of heat transfer and storage elements (23) are completely or partially coated with one or more catalysts (92) to promote a chemical reaction in the fluid (1).

The catalyst (92) may be a substance that accelerates a chemical reaction without being consumed in the process. In this context, the catalyst (92) facilitates the desired chemical transformation within the fluid (1) as it passes through the heat transfer and storage elements (23). Also, by incorporating the catalyst (92) into the heat transfer and storage elements (23), the system (100) can be adapted to perform a wider range of functions, such as becoming a continuous or flow reactor, and achieve higher levels of efficiency and selectivity.

On the other hand, the heat transfer and storage subsystem (20) may be insulated by the insulation subsystem (24) to minimize the energy losses in the surrounding environment.

The insulation subsystem (24) consists of at least one layer of insulating materials. The insulating materials can be selected from the group consisting of high-performance ceramic fibers, refractory mortars, high-temperature tiles or bricks, foams of organic or inorganic materials (e.g., phenolic foams, carbon foams), Kevlar ceramic papers, gel-derived synthetic porous ultralight materials in which the liquid component has been replaced with a gas or any other materials known to a person of ordinary skill in the art, or a combination thereof.

In any of the embodiments of the system (100), the insulation subsystem (24) is composed of refractory material or an insulating material, wherein the insulation subsystem (24) comprises at least one insulation layer (37) made of insulating materials.

The insulating materials are selected from the group consisting of high-performance ceramic fibers, refractory mortars, high-temperature tiles or bricks, foams of organic or inorganic materials, phenolic foams, carbon foams, Kevlar ceramic papers, gel-derived synthetic porous ultralight materials in which a liquid component is replaced with a gas, or any other materials known to a person of ordinary skill in the art, or a combination thereof.

On the other hand, the insulation layer (37) may be a component designed to minimize heat loss and maintain thermal efficiency.

In one embodiment of the system (100), at least one insulation layer (37) comprises a vacuum chamber or a chamber filled with a low thermal conductivity fluid. The vacuum chamber creates a near-vacuum environment, significantly reducing the thermal conductivity of the insulation subsystem (24). The above is because the heat transfer through conduction and convection is minimized in the absence of a medium to transmit heat.

On the other hand, filling the chamber with a fluid that has a low thermal conductivity, such as a noble gas or a specialized low-conductivity fluid provides good thermal insulation to the insulation subsystem (24), especially when combined with other insulation techniques.

In one embodiment of the system (100), the insulation subsystem (24) comprises a composite material (38) containing the insulation subsystem (24).

The composite material (38) may be a combination of two or more materials, each with specific properties, that are combined to form a new material with enhanced characteristics. In this case, the composite material (38) may be used to improve the insulation properties of the insulation subsystem (24).

Additionally, the composite material (38) may be selected from the group consisting of organic or inorganic resins or cermets, with or without reinforcing, wherein the reinforcing is made of fibers or particles of organic or inorganic materials, metals, cermets, or any other material known to a person of ordinary skill in the art, or a combination thereof.

Referring to FIG. 6, the system (100) may also comprise a fluid circulation system (90) connected to the heat transfer and storage subsystem (20). The fluid circulation system (90) comprises a set of elements that may include a fan, a compressor, a pump, or any other device commonly used to move fluids, a set of ducts, valves, dampers, expansion joints, filters, control, and safety devices.

The fluid circulation system (90) is used to transport energy in the form of heat to and from the industrial process (300) that requires or generates it and through the heating subsystem (10).

The method of integration with the industrial process (300) can be open as shown in FIG. 8A, or closed loop as shown in FIG. 8B, and FIG. 8C. In the open loop method, a fluid, for example, air, is taken from the atmosphere through a fan or a compressor and is forced to pass through the heat transfer and storage subsystem (20).

The fluid (1) takes the energy by radiation and convection from the set of heat transfer and storage elements (23) in the heat transfer and storage subsystem (20), thereby raising its temperature. This energy is then delivered to the industrial process (300) by transporting the fluid (1) through high-temperature ducts, valves, dampers, or any means necessary, e.g., as the fluid circulation system (90). Once the fluid (1) does the work on the industrial process (300), the fluid (1) is discharged.

In the closed loop method, once the fluid (1) does the work, the fluid (1) is then recirculated to the heat transfer and storage subsystem (20) and any remaining energy is then harnessed by the heat transfer and storage subsystem (20).

Since some fluids containing oxygen and nitrogen, e.g. air, can produce thermal NOx at temperatures above 1300° C., an additional advantage of the closed loop method is the significant reduction of NOx emissions.

In one embodiment of the system (100), NOx can be removed using a method such as a Selective Catalytic Reduction (SCR) and/or Selective Non-Catalytic Reduction (SNCR) or any other method known to a person of ordinary skill in the art.

In some embodiments of the system (100), the heating subsystem (10) comprises a cooling circulation system (93). Some components of the heating subsystem (10), like the power electronics, require cooling to maintain a reliable operation. The cooling circulation system (93) corresponds to a close circuit comprised of a set of pipes, pumps, and valves that circulate a refrigerant fluid through heat exchangers or through the heating sources themselves, thereby removing the heat produced by the power electronics and the coil (10A) as they constitute energy losses to the system (100).

In one embodiment of the system (100), the energy captured by the cooling circulation system (93) is harnessed in the fluid circulating system (90) by means of a heat exchanger recuperator (91). The heat exchanger recuperator (91) may be installed at the atmospheric inlet in open loop configurations or the process outlet in the closed loop configuration or both.

On the other hand, the electrical feeding subsystem (80) may be connected to an energy source (81) and includes all necessary equipment to feed electricity to the heating subsystem (10). The electrical feeding subsystem (80) may be an element of the system (100), providing the necessary electrical power to operate the heating subsystem (10). Also, the electrical feeding subsystem (80) allows the heating subsystem (10) to have a continuous and reliable supply of energy, enabling it to generate heat efficiently.

In any of the embodiments of the system (100), and referring to FIG. 2, the energy source (81) to which the electrical feeding subsystem (80) is connected is selected from electricity in the form of direct current or alternating current, at any voltage level and any frequency, in the form of continuous or intermittent power, drawn from the grid or from off-grid electricity sources, wherein the electrical feeding subsystem can be frequency and voltage independent.

In the case wherein the energy source (84) is electricity, the electrical feeding subsystem (80) can be connected to the grid through appropriate transformers to provide the adequate frequency, current, and voltage required by the induction or microwave systems. However, the electrical feeding subsystem (80) can also be connected to a solar panel array, a wind turbine generator, or any other renewable energy source.

When the electrical feeding subsystem (80) is connected to the grid, the heating subsystem (10) requires an AC/DC converter to transform the frequency of the grid or the energy source to Direct Current. Whereas, when the electrical feeding subsystem (80) is connected to a DC electricity source, for example, a solar PV power plant, a large simplification of the electrical installation can be achieved.

The installation method consists of removing the solar or wind frequency regulation elements, e.g., inverters, and delivering DC current to the heating subsystem (10). Since the heating subsystem (10) can work with DC, the DC/AC inverter on the solar panels array, and the AC/DC rectifier that is required to feed the oscillator or the microwave generator can be disregarded thus reducing the capital expenses of these installations significantly.

In another installation method, some inverters of a PV array or the wind generators not connected to the grid can be designed and configured to provide the frequency required in the heating subsystem (10) to generate the electromagnetic field or the electromagnetic waves, thus using AC current but at an appropriate frequency. Since the frequencies required for induction or microwave heating are superior to those on the grid, the transformers used to elevate the voltage, when needed, will be lighter and require less core material to transfer the same amount of power. An advantage of the above is that it eliminates the need for an AC/DC rectifier and a DC/AC oscillator in the heating subsystem (10) when using induction or microwaves as heating energy sources.

In one embodiment of the system (100), the electrical feeding subsystem (80) is connected to an off-grid electricity source (84), wherein the components required to match the grid frequency are removed and deliver direct current or variable frequency current to the heating subsystem (10). One advantage of connecting the electrical feeding subsystem (80) to an off-grid electricity source (84) is the increased autonomy and reliability of the system (100) by eliminating the dependence on a traditional grid power supply, the system (100) may operate independently, reducing the risk of power outages and ensuring continuous operation. In addition, by utilizing renewable energy sources or other off-grid power generation methods, the system (100) can reduce operating costs associated with grid electricity, as well as reducing electricity cost and grid stress, ad large loads can induce significant demands on the grid. Also, off-grid power sources, such as solar or wind power, can have a lower environmental impact compared to traditional grid-based power generation. Finally, by decoupling from the traditional grid, the system (100) gains flexibility and resilience, making it suitable for remote or off-grid applications or applications where the is no adequate grid infrastructure.

In one particular embodiment of the system (100), the electrical feeding subsystem (80) is connected to the off-grid electricity source (84), wherein the frequency of the source (84) is configured in such a way that it matches the frequency required by the heating subsystem (10). Regarding the above, by configuring the frequency of the off-grid electricity source (84) to match the frequency required by the heating subsystem (10), the power electronics required can be disregarded thus significantly reducing cost.

The post-heating subsystem (50) allows for further increasing the temperature of the fluid (1) circulating through the heat transfer and storage subsystem (20) beyond the limits of the heating subsystem (10).

Referring to FIG. 1, in one embodiment of the system (100), the fluid (1) heated by the heat transfer and storage subsystem (20) is post-heated by the post-heating subsystem (50) after passing through the set of heat transfer and storage elements (23) by changing the phase of the fluid (1) heated into plasma.

It may be understood in the present disclosure that plasma refers to a state of matter consisting of a collection of free electrons, ions (atoms or molecules that have lost or gained electrons), and neutral particles.) Plasma, which the fourth state of matter, can reach extremely high temperatures, far exceeding those achievable through conventional heating methods.

The fluid (1) is initially heated by the heat transfer and storage elements (23), afterward the fluid (1) heated is then subjected to a strong electric field or electromagnetic radiation, which ionizes the atoms or molecules, creating a plasma, and the high-energy plasma transfers its energy to the remaining fluid (1), further increasing its temperature. Advantageously, by incorporating plasma heating into the system (100), the overall thermal energy output and the range of potential applications of the system (100) can be significantly expanded to applications where temperatures beyond 1500° C. are required.

A method for generating plasma consists of subjecting the heated fluid (1) to a strong electromagnetic field, to high energy subatomic particles or to a high electrical voltage, by gaseous discharge such as corona discharge or arc discharge, by methods such as magnetically induced plasmas, microwaves, static electric sparks, capacitively coupled plasmas, dielectric barrier discharges, or any other method known to a person of ordinary skill in the art, or a combination thereof.

Referring to FIG. 8A, FIG. 8B, and FIG. 8C, in any of the embodiments of the disclosure herein, the system (100) is integrated with the industrial process (300) by means of an open loop or a closed loop to the fluid circulation system (90).

Particularly, the system (100) may utilize waste heat from the industrial process (300), reducing energy consumption and improving overall efficiency. Also, the system (100) may be tailored to match the specific energy needs of the industrial process (300), minimizing energy losses. The system (100) may adapt to changing process conditions, ensuring optimal performance.

By improving energy efficiency and reducing the reliance on fossil fuels, the system (100) can contribute to lowering greenhouse gas emissions. The integration of the system (100) with the industrial process (300) may lead to more sustainable and environmentally friendly industrial processes. Also, by recovering and reusing waste heat, the system (100) can reduce energy consumption and lower operational costs. In summary, by integrating the system (100) with at least one industrial process (300), it is possible to achieve significant benefits in terms of energy efficiency, environmental sustainability, and economic viability.

The present disclosure also describes an array (400) for the generation, storage, and transfer of thermal energy. Preferably, the array (400) is comprised of any embodiment of the system (100).

The array (400) may be made of an array of at least two heating subsystems (10) arranged in such a way that the outlet of a first heating subsystem (10) can be configured to be the inlet of the next.

When the set of heat transfer and storage elements (23) of the heat transfer and storage subsystem (20) lose their temperature and reach a target outlet temperature (44) required by the industrial process (300), the first heating system is considered depleted as the energy stored is no longer useful for the industrial process (300).

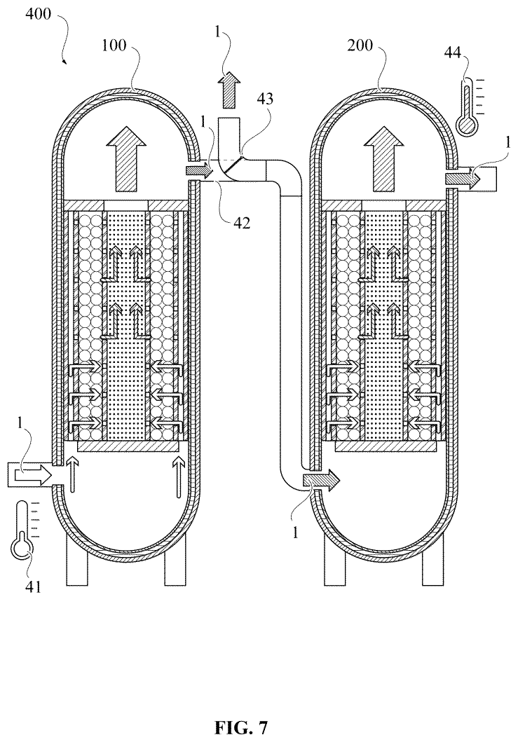

Referring to FIG. 7, in one embodiment of the array (400), said array (400) comprises a first system (100), a second system (200) connected to the first system (100), wherein the outlet of a first heat transfer and storage subsystem (20) of the first system (100) is configured to be the inlet of the heat transfer and storage subsystem (20) of a second system (200), wherein a set of heat transfer and storage elements (23) of a heat transfer and storage subsystem (20) of the first system (100) transfers energy to a fluid (1) to approach the target outlet temperature (44) required by the industrial process (300), wherein if the temperature of the fluid (1) in the first heat transfer and storage subsystem (20) does not provide enough temperature to reach the target outlet temperature (44), an outlet (42) of the first system (100) is diverted by means of a diverter (43) to a second heat transfer and storage subsystem (20) of the second system (200), and wherein the fluid (1) enters pre-heated by the heat transfer and storage subsystem (20) of the first system (100) to the second heat transfer and storage subsystem (20) in such a way that the fluid (1) is able to reach the target outlet temperature (44) required by the industrial process (300).

The target outlet temperature (44) is the specific temperature required by the industrial process (300) for optimal performance and efficiency. The target outlet temperature (44) may vary depending on the nature of the process, such as chemical reactions, e.g., specific temperature ranges are often required to initiate or optimize chemical reactions, material processing, e.g., different materials may require different temperatures for melting, shaping, or other processes, and energy generation, e.g., the temperature of the fluid (1) may influence the efficiency of energy conversion processes.

In this embodiment of the array (400), the fluid (1) with an initial temperature (41) is initially heated in the first system (100), and the temperature of the fluid (1) is monitored and compared to the target outlet temperature (44). If the temperature of the fluid (1) is insufficient to reach the target outlet temperature (44), the fluid (1) is diverted to the second system (200) for further heating by means of the diverter (43) through the outlet (42) of the first system (100). Finally, the second heating subsystem (20) in the second system (200) provides additional heat to the fluid (1), ensuring that said fluid (1) reaches the desired target outlet temperature (44).

The diverter (43) is selected from the group consisting of gates, hatches, valves, pipes, or any other diverting elements known to a person of ordinary skill in the art, or a combination thereof.

In another embodiment of the array (400), the first system (100) and the second system (200) are similarly configured to work with systems (500) (not illustrated) and are arranged in a configuration in series, parallel, or a combination thereof. The systems (100, 200, 500) may work as a direct heating method or energy storage method.

The main advantage of making an array (400) comprising at least two systems (100) for generation, storage, and transfer of thermal energy is that said array (400) increases the energy density per unit volume of the system (100) by increasing the depth of discharge. For instance, if the energy is stored at 1000° C. and the fluid (1) needs to be heated to 500° C., only 50% of the energy stored is accessible, which means 50% depth of discharge. If at least two heat transfer and storage subsystems (20) are configured in series as described above, 75% of the energy is accessible, if there are, for example, six heat transfer and storage subsystems (20) up to 92% of the stored energy is accessible and so on. This allows for a nonlinear scalability of the storage capacity of the array (400), reducing its cost per unit energy stored as well as reducing footprint.

It should be understood in the disclosure herein that systems (200, 500) are similar to the system (100) and that said systems (200, 500) may be configured in any of the embodiments of the system (100).

Advantages of the system (100) and the array (400) include high energy density and high depth of discharge. The above by storing energy in the form of thermal energy at very high temperatures, in high energy dense materials, and by harnessing both latent and sensible heat in the set of heat transfer and storage elements (23), extreme high energy densities close to 1.5 MWh/m³ can be attained. Furthermore, by arranging the heat transfer and storage subsystem (20) in series or in parallel, most of the energy stored is accessible allowing for a high depth of discharge at the required target outlet temperature (44)

Also, the system (100) and the array (400) allow reaching a high delivery temperature. Using a heating system that does not limit the temperature of the fluid (1) to the physical properties of the materials used to produce heat, allows for much higher temperatures of the set of heat transfer and storage elements (23), and therefore allows for fluids heated at very high temperatures. The above helps to achieve decarbonization of hard to abate industries and processes that require temperatures over 1000° C. not attainable by other means without combustion and therefore emissions.

Likewise, the system (100) and the array (400) allow robustness and reliability. The system (100) and the array (400) make use of well proven and robust technologies used in other processes for different purposes in other industries and for other applications reducing the technology risk. For instance, induction and microwave heating are widely used as heat sources in industrial processes, a packed bed heat exchanger with nuclear fuel is used in high temperature gas cooled reactors.

Furthermore, the system (100) and the array (400) allow flexibility. A stream of hot fluids, in particular gases at temperatures over 1000° C., can replace existing fossil fuels burners in processes wherein the combustion gases are the source of energy, e.g. the combustion chamber of a boiler, making the system (100) and the array (400) plug and play in most cases, replacing or operating alongside existing infrastructure. This reduces capex and risk for customers, allows decarbonization whilst maintaining existing infrastructure. Moreover, the system (100) and the array (400) may act as direct electrification, thermal storage, or both.

The system (100) and the array (400) also provide scalability. The possibility of achieving high depths of discharge, and the use of different materials to generate and store thermal energy allows scaling in an exponential manner, meaning that in a small footprint the system (100) and the array (400) may serve giga-Watt hour industries such as cement, smelting, refineries, glass and ceramic, etc.

Likewise, the system (100) and the array (400) allow more efficiency. Over 95% electricity to heat conversion rates makes the system (100) and the array (400) as efficient as resistors and more efficient than hydrogen, Li-Ion and other electrical batteries, and any other system currently used in industry for electrical heat generation.

Furthermore, the system (100) and the array (400) allow low pressure to drop in the heating subsystem (10), due to the fact that the system (100) and the array (400) present a low pressure drop due to the radial flow configuration, increasing the overall efficiency of the system (100) and the array (400).

Finally, the system (100) and the array (400) are competitive. The levelized cost of heat is competitive against natural gas and many other fuels in most geographies.

### EXAMPLES

### Example 1

Referring to FIG. 1, an embodiment of the system (100) was developed, there was a power management system that captured information from heating process parameters and regulates power to the heating subsystem (10) and outlet temperature in the circulating fluid (1).

The power management system was comprised of hardware and software. The hardware architecture included a master controller, a heating system controller and a gateway switch to exchange process information parameters with the industrial plant. The power management system was configured to control the process parameters from the heating subsystem (10), a heat transfer and storage subsystem (20), a fluid circulation system (90), a cooling circulation system (93), an electrical feeding subsystem (80), a carbon management system, and a post heating system (50) based on data collected from internal process parameters.

Also, the power management system collected process data for instance, pressure, temperature, fluid flow, process energy requirements, process energy conditions, market signals such as historical and projected availability and price of electricity and fuels, or any other variable relevant for the operation, control, and safety of the system (100). These variables were measured with sensors that were selected from a group of sensors and methods including thermometers, thermocouples, resistance temperature detectors, infrared thermometers, thermistors, pitot tubes, pressure sensors, encoders, position sensors, current transformers, hall effect sensors, or any method known to a person of ordinary skill in the art, and combinations thereof. The variables could also have been manually entered into the energy management system by a human operator or sent from other equipment using any known method for such an operation.

The power management system were selected from the group consisting of programmable logic controllers (PLCs), microprocessors, DSCs (Digital Signal Controllers), FPGAs (Field Programmable Gate Arrays), CPLDs (Complex Programmable Logic Devices), ASICs (Application-Specific Integrated Circuits), SoCs (System on Chip), PSoCs (Programmable System on Chip), computers, servers, tablets, smartphones, signal generators, and equivalent control units known to a person moderately skilled in the art, and combinations thereof.

Also, the power management system controlled the heating system parameters to achieve direct and accurate temperature control of heating subsystem (10), and indirectly controlled the set of heat transfer and storage elements (23) parameters for customer process control. Some applications require accurate process control to guarantee customer product quality.

A method of integrating industrial process quality parameters consisted in the implementation of a feedback control through the power management system. A three-element control that operated with temperature feedback control, a flow dilution with bypassed flow or fresh fluid flow, and a mass flow rate forward control with variable frequency drives to adjust the operating point of the compressor, fan or pump to provide the control robustness to operate either in direct heating or energy storage methods.

In one implementation of the system (100), there was a Carbon management system that monitors customer process, energy market conditions and energy availability and prices to optimize the carbon emission based on energy sources availability.

The carbon management system was comprised of hardware and software. The hardware architecture included a microgrid controller and a gateway to the cloud. The carbon management system collected data from the field and the internet, such as energy availability and cost (historical, current, and forecasted) from any source, process energy requirements, energy prices (current and futures) and all other process data, to make automated decisions on which energy source to use for the customer industrial process.

Additionally, the carbon management system comprised an artificial intelligence (AI) based algorithm that used the customer carbon emission reduction goals, and real time data information to make automated decisions on which energy source to use, when to store or discharge the TES and whether it was necessary to use nonrenewable energy sources such as natural gas or other fuels making the system a true hybrid system (renewable/nonrenewable).

With the implementation described above, the system (100) provided a groundbreaking solution that was integrated in a process that previously used natural gas. It delivered clean, high-temperature heat with exceptional efficiency and flexibility. The operation significantly reduced CO₂ emissions while maintaining consistent energy output. The system (100) enabled seamless functionality across variable demand cycles. It leveraged renewable heat during peak availability and supplemented with natural gas as needed.

This integration enhanced the sustainability of industrial processes, reduced dependency on fossil fuels, lowered operating costs, and ensured compliance with environmental regulations without compromising performance.

### Example 2

In one implementation of the system (100) for power generation, the heat transfer and storage subsystem (20) is able to capture electricity from the grid or directly from a renewable energy source such as solar photovoltaic plant or wind turbine generators and convert this power into heat at very high temperature

The energy stored in the heat transfer and storage subsystem (20) is removed with a flow of a compressed gas suitable for heat transfer purposes. The gas was compressed by the gas turbine compressor and moved through the heat transfer and storage subsystem (20). Also, the heated gas exits the thermal energy transfer and storage system carrying a very high temperature suitable for gas turbine operation. The gas circulated through the turbine section, transferring its energy into the rotational shaft of the turbine, while the gas expanded and reduced its temperature.

Furthermore, the colder gas exits the gas turbine section still holding a high temperature (approximately 550° C.), so the energy remaining in the gas could still be used to heat up a steam Rankine cycle with 1, 2 or 3 pressure levels including reheat cycles like conventional combined cycle power plants.

The great advantage of this application is that in the electricity markets up to date, combined cycle Peaker plants are burning natural gas to provide fast response during peak electricity consumption hours. With the system and method disclosed herein, the Peaker plants in the electricity markets can operate by charging their Thermal Energy Storage (TES) units during low-cost electricity hours, for example when solar power generation is at peak and electricity is curtailed or prices go low or even negative, to later dispatch the energy at the peak electricity periods in the market, all this without burning a molecule of fossil or other type of fuels.

Furthermore, if the colder gas exits the gas turbine section still holding a high temperature (>550° C.), the heat can also be used in industrial heating processes like steam for power or processes, hot gas for drying, curing or any similar industrial processes that require heat at a 500° C. degree range. This combined heat and power application can produce electricity and heat to the industries, all of it without burning fossil fuels and available during the 24 hours of the day, as the system can be sized to store enough energy to cover the daily industrial plant demands.

The system (100) could be therefore integrated with a gas turbine power generation unit, to operate like a combined cycle power plant powered by renewable energy stored in heat transfer and storage subsystem (20). The solution can operate as a zero-carbon thermal power Peaker plant or zero carbon combined heat and power-based load plant with very high efficiency in both applications.

Additionally, when the cold gas exits the steam generator or the industrial process can be captured with ducts and returned into the compression inlet, in this way, the energy still available at low temperature at the outlet of the process, is recirculated and this energy loss, very common in combustion systems is recovered, increasing the overall energy efficiency of the thermal processes.

To make this integration possible, the heat transfer and storage subsystem (20) comprises:
a system able to reach very high temperatures and pressure to power a Brayton cycle;
a system with very low pressure drops to facilitate the integration with a gas turbine generator replacing the combustion system of a conventional Brayton cycle;
a system that can be pressurized as compression is a key process of the Brayton cycle; and
a system that can work with different gases.

All these attributes have been intentionally included in the design of heat transfer and storage subsystem (20) to facilitate the integration of the TES with the applications described above.

### Example 3

An application of the system (100) in a Drying process is shown. Particularly, Drying is a process of removal of water or another liquid, by evaporation of a solid, semi-solid or liquid-solvent mixture.

In food processing and pharmaceuticals industries the solvent to be removed is always water. In mineral processing the extracted ore is usually crushed and passed into a wet beneficiation process to remove impurities, often with water and/or chemicals so that it is prepared for the industrial process.

Drying of raw materials prepares the material for processing and makes the industrial process more economical in many ways, for example, the process does not transport water all the way, avoids material build up, avoids materials to harden, etc. Also, Drying is also critical in producing pelletized materials for the markets.

In the above Drying processes, it is usual that heat is produced by burning fossil fuel like natural gas. By implementing the system (100), the thermal energy transfer and storage system charged with electricity from the grid or directly from a renewable energy source such as solar photovoltaic plant or wind turbine generators, can produce a hot gas stream to replace the combustion system of the industrial dryers.

In this application, the energy stored in the set of heat transfer and storage elements (23) can be removed with a flow of air, and the heat is transported into the process. The characteristics of the material to be processed define the requirements of Drying process and hence, the gas flow conditions like temperature, flow rate, etc. On the other hand, to guarantee the product quality it is critical to reach a precise moisture content in the material, therefore, the heat transfer and storage subsystem (20) is equipped with a power control system to produce a hot gas stream at the target process temperature and mass flow of air required by the dryer.

In an embodiment of the system (100) for this kind of application, the colder fluid exiting the Drying process carries the moisture removed inside the dryer and it is released to the atmosphere as an open system. In a second embodiment for this kind of application, the colder fluid flows in a closed loop, passing through a tank where the moisture is removed by cooling the fluid stream below its dew point to condense all moisture carried within the fluid.

The fluid-cooling process consists in an gas tank equipped with a heat transfer coil to cool down the fluid stream, the heat is captured in the thermal fluid flowing inside the coil, it is transported out of the tank and it is returned back to the cold fluid stream through a heat exchanger recuperator that can be a shell-tube type heat exchanger or any other suitable heat exchanger to preheat it and circulate back the air into the compressor or blower inlet. In this way, a closed loop air drying system is integrated with the heat transfer and storage subsystem (20) achieving higher thermal efficiency than conventional dryers, due to the benefit that heat transfer and storage subsystem (20) do not circulate combustion flue gases but a rather clean fluid stream through the dryer and back into the heat transfer and storage subsystem (20). Both embodiments do not produce carbon emissions as the energy source for the Drying process is electricity from renewable energy sources.

### Example 4

An application of the system (100) in a Curing process is shown. Particularly, a Curing process is a chemical process that produces hardening of a material by induced heating.

The curing method depends on the resins and applications. In many cases, the resins are thermally activated with a catalyst. To achieve vitrification in the resins, it is usually necessary to increase the process temperatures. Different processes will require different process temperatures ranging from 150° C. to 800° C. Current technologies use natural gas combustion systems to provide the heat required by the process.

Based on the system (100) disclosed herein, a heat transfer and storage subsystem (20) can supply a very high temperature hot gas to the curing furnace. This embodiment allows the curing process to occur without burning fossil fuels thus avoiding their carbon emissions to the atmosphere.

In this application, the heat transfer and storage subsystem (20) supplies a stream of hot gases at the right temperature conditions to transfer heat to the material increasing its temperature. Process control parameters are monitored via temperature sensors and a power management system adjusts power requirements to match the process required conditions.

The colder gas at the furnace exit can be captured with ducts and returned to the heat transfer and storage subsystem (20) inlet. In this embodiment, the lower temperature available in the gas leaving the furnace can be captured and returned into the process increasing the overall thermal efficiency of the furnace. In the conventional curing furnace, the heat available in the gas leaving the furnace is lost when the flue gases are released into the atmosphere.

### Example 5

An application of the system (100) in a Distillation process is shown. Distillation is a process of separation of substances of a liquid mixture by using boiling and condensation. In addition, Distillation is applied in many industries like beverages, desalination, chemical synthesis, gas and oil processing, fractionation of fuels and chemical feedstocks, etc.

The process requires heating for the substances to reach a specific target temperature before it enters a distillation tower. The heating process is often provided by combustion of fossil fuels within a furnace that embeds a coil. The substances flow inside the coil getting heated by convection and radiative heat transfer from the furnace.

Based on one embodiment of the system (100) disclosed herein, a heat transfer and storage subsystem (20) can supply a very high temperature hot gas to the Distillation process, replacing the heat produced by combustion of fossil fuels. Hot gas transfers heat to the substance in the coil by means of a convective cross flow heat exchanger to achieve accurate temperature control in the substance before it enters a distillation column.

The colder gas at the exit of the furnace can be captured with ducts and returned into the compressor or blower inlet from the gas circulation system. Thus, the overall thermal efficiency of the process is higher than conventional open systems with flue gases sent to the environment through the furnace stack.

### Example 6

An application of the system (100) in a Clinkerization process is shown. Clinkerization is a process in the production of Cement that involves the conversion of raw meals into clinker minerals. The process demands high temperature heat at about 1450° C. Typically, the combustion of fuels is the only path to provide heat for the process. Additional process heat is added from the hot gases coming from a clinker cooler.

Based on one of the embodiments of the system (100) disclosed herein, a heat transfer and storage subsystem (20) can supply a very high temperature hot gas to a clinker furnace. This embodiment allows the sintering process to occur without burning fossil fuels thus avoiding their carbon emissions into the atmosphere.

In this application, the heat transfer and storage subsystem (20) supplies a stream of gas at very high temperature (1450° C.), preferably CO2 or an inert gas atmosphere. The gas that flows through the clinker cooler gets preheated up to 900° C. before it is carried back inside the heat transfer and storage subsystem (20). Furthermore, the heat transfer and storage subsystem (20) raises the hot gas temperature up to the required process conditions, 1450° C. or more, then, it enters the clinker furnace, where the reaction occurs.

The gas exits the clinker furnace and flows into the cyclone preheater tower. Finally, the gas is captured with an induced draft fan downstream of the bag house. The colder gas is captured with ducts and returned into the clinker cooler inlet making a closed loop gas circuit.

### Example 7

An application of the system (100) in a Calcination process is shown. Particularly, Calcination is a thermal process to remove impurities from solid compounds by thermal heating at very high temperatures without melting the compound. The most known Calcination is usually carried out to decompose carbonate ores to produce lime, but there are other relevant processes like decomposition of mineral hydrates like Bauxite to produce alumina, and more

Calcination is usually realized in furnaces or reactors like rotary kilns, vertical calciners, and fluidized bed reactors. Calcination temperature depends on the specific reaction that takes place, for example, the decomposition of limestone into lime and CO2 in the cement industry occurs at temperatures between 900 to 1150° C.

Based on one of the embodiments of the system (100), a heat transfer and storage subsystem (20) can supply the high temperature heat required by the calciner kiln by circulating a gas stream of CO2 produced by the kiln reaction into heat transfer and storage subsystem (20) using very high temperature CO2 gas as the heat carrier.

The heat transfer and storage subsystem (20) replaces the furnace system that burns fossil fuels to provide the heat required by the kiln, at the exact same conditions that are required by the combustion system.

In the lime production case, the Calcination process produces additional CO2, hence, a tail of CO2 gas is diverted from the circulating gas stream, and this tail of gas is stored for other industrial uses.

Clay calcination is another example wherein the embodiment of the system (100) disclosed herein can make a large contribution to reducing the CO2 production in making cement. In this application, clay is calcined in a rotary kiln or calciner at 900 to 1150° C., whereas the heat is provided with a heat transfer and storage subsystem (20). The heat gas carrier is CO2 and the colder gas stream leaving the calcination process can be used to preheat the fresh clay feed. Downstream of the preheater, the cold gas stream is captured and returned in heat transfer and storage subsystem (20) recirculating any waste heat stream, thus increasing the thermal efficiency of the process.

### Example 8

An application of the system (100) in a Pyrolysis process is shown. Pyrolysis is a process of thermal decomposition that occurs at high temperatures under inert atmospheres. It is extensively used in the chemical industry, to produce solids like char, condensable liquids like light and heavy oils and tars, and non-condensable gases with or without presence of catalysts (thermal cracking and fluid catalytic cracking).

When Pyrolysis is used to produce ethylene, hydrocarbons from petroleum are heated to 600° C., in the presence of steam, (steam cracking). The resulting ethylene is used mainly for the plastic industry.

The process is also applied in the production of hydrogen from methane in presence of steam to remove solid carbon, (methane pyrolysis or steam methane reforming).

Based on any of the embodiments of the system (100), a heat transfer and storage subsystem (20) can supply the high temperature heat required by the Pyrolysis process. One method is the transfer of heat by means of a shell and tube heat exchanger to heat up a fluid liquid feed, whereas the colder gas stream leaving the heat exchanger can be captured and returned to the compressor or blower inlet to increase the thermal efficiency of the process.

Additionally, a second heat transfer and storage subsystem (20) operating in a closed loop circuit with an inert gas like CO2 as heat carrier, can activate the reaction catalyst inside the catalyst regenerator unit. The heat transfer and storage subsystem (20) heats the CO2 to circulate through a gas-steam heat exchanger necessary to feed the steam cracking reactor.

Another method disclosed herein integrates a heat transfer and storage subsystem (20) with a steam methane reformer reactor to supply high temperature gas within a range of 800 to 900° C. and at a pressure of 20 to 30 Bar. The heat gas carrier can be an inert gas like CO2, such that an additional capture or separation process for CO2 is not required.

In the methane reforming process, additional CO2 is produced, hence, a tail of CO2 gas is diverted from the circulating gas stream, and this tail of gas is stored for other industrial uses.

### Example 9

An application of the system (100) in a Smelting process is shown. Particularly, Smelting is a process to extract a metal from a chemical compound by applying heat and a catalyst reducing agent to produce a syngas that reacts with the metal oxide, to free the metal. Prior to the smelting process, some applications require a roasting process where metal sulfides and/or metal carbonates that are present in the ore undergo thermal decomposition to leave metal oxides that can react in the smelting process to remove the metal.

The required temperature in the smelting process depends on the type of mineral it can be recovered. Smelting applies to copper, iron, lead, zinc, and silver. All Smelting process applications use fossil fuels as the heat source for chemical reactions to occur. Therefore, the Smelting processes are large emitters of CO2 to the atmosphere.

Based on one embodiment of the system (100) disclosed herein, a heat transfer and storage subsystem (20) can supply high temperature heat by means of an inert hot gas, preferably CO2. The method to transfer heat for the reaction to take place is by direct contact with the ore mineral and catalyst inside the smelter furnace. The high temperature heat partially reduced the Carbon dioxide into carbon monoxide and carbon from coke, through the Redox reaction at a given temperature. The Redox (reduction-oxidation) reaction (Boudouard reaction) indicates that at high temperatures, the CO2 reverse reaction toward CO is dominant even though the reaction is still exothermic. In this way, a heat transfer and storage subsystem (20) using a reducing atmosphere with CO2, can produce CO to react with the metal oxides in the ore and free the metal from the compound.

Furthermore, the CO2 produced during the roasting process in the presence of carbonates or during the oxidizing process are captured and returned to the compressor inlet. Finally, a tail of CO2 gas might be diverted for storage.

It should be understood that the invention described in the present disclosure is not limited to the embodiments described, and illustrated, as it will be evident to a person skilled in the art that there are variations, and possible modifications that do not depart from the spirit of the invention, which only is defined by the following claims.

1. A system (100) for generation, storage and transfer of thermal energy, comprising:
a heating subsystem (10);
a heat transfer and storage subsystem (20) connected to the heating subsystem (10);
a post heating subsystem (50) connected to the heat transfer and storage subsystem (20); and
an electrical feeding subsystem (80) connected to the heating subsystem (10), the heat transfer and storage subsystem (20), and the post heating subsystem (50),
wherein the heat transfer and storage subsystem (20) and the post heating subsystem (50) are configured to change the temperature of a fluid (1).

2. The system of claim 1, wherein the heat transfer and storage subsystem (20) comprising a heat exchanger apparatus (21), wherein said heat exchanger apparatus (21) comprises a structure (22) with an inlet (22A) and an outlet (22B); and wherein the structure (22) has a longitudinal axis.

3. The system of claim 2, wherein the heat exchanger apparatus (21) comprises:
a structure (22) comprising an inlet (22A) and an outlet (22B), wherein the structure (22) comprises at least one wall (22C) having an internal surface through which the fluid (1) flows and said at least one wall (22C) being formed with a reticulated or lattice structure;
a set of heat transfer and storage elements (23) disposed inside the structure (22);
an insulation subsystem (24) covering the structure (22) and configured to minimize heat losses to the surrounding environment; and
a driving device (25) connected to the structure (22) and configured to generate the displacement of the fluid (1) inside the structure (22);
wherein the fluid (1) interacts with the set of heat transfer and storage elements (23); and
wherein the heat exchanger apparatus (21) is configured to allow the passage of the fluid (1) from the inlet (22A) to the outlet (22B) and vice versa,
wherein the temperature of the heat transfer and storage elements (23) is different from the temperature of the fluid (1).

4. The system of claim 2, wherein the structure (22) is selected from the group which includes vessels, ducts, conduits, containers, tubes, channels and pipes configured to support gage pressures above 0.1 bar.

5. The system of claim 3, wherein the fluid (1) flows through the set of heat transfer and storage elements (23) and parallel to the axis of the structure (22).

6. The system of claim 3, wherein the fluid (1) flows through the heat transfer and storage elements (23) and nonparallel to the axis of the structure (22).

7. The system of claim 3, wherein the structure (22) has an inner space, said space has multiple partitions (30) along the axial axis of the structure (22) configured to increase the surface area of the structure (22).

8. The system of claim 2, wherein the structure (22), the outer duct (26), the inner duct (27), the intermediate duct (28) and the partitions (30) are made of several layers (31), wherein some layers (31) are configured for increasing the surface area exposed to electromagnetic field or electromagnetic radiation or conductive, convective or radiant heat, wherein said layers (31) can be electrically insulated between them.

9. The system of claim 3, wherein the heat transfer and storage elements (23) are selected from the group which includes particles, fibers, three-dimensional geometric elements selected from the following group: spherical shape, pyramids, cones, disks, prisms, cubes, spheres, parallelepipeds, cylinders, hyperboloids, or any other three-dimensional shape, open or closed cell foams or porous materials with random or pseudo-periodic pore structures, triple periodic minimal surfaces (TPMS) for example Gyrod surfaces, Schwarz P surfaces, Schwarz D surfaces, Fischer-Koch S surfacs, Lattice-Based Cellular Structures or any other TPMS, a mesh or combination thereof that allows the fluid (1) flowing through them or through an array of them.

10. The system of claim 3, wherein the heat transfer and storage elements (23) are made of a material configured to conduct energy in the form of heat, electricity, electromagnetic fields or a combination thereof.

11. The system of claim 3, wherein the material from which the set of heat transfer and storage elements (23), the structure (22), the outer duct (26), the inner duct (27), the intermediate duct (28) and the partitions (30) are made is selected from a group of materials consisting of carbon steel, silicon steels, tungsten disiliside, nickel-based super alloys, cast iron, galvanized iron, chromium steels, chromium-nickel steels, chromium-nickel-titanium steels, nickel-chromium-molybdenum-tungsten alloys, ferrous alloys with chromium-molybdenum, stainless steel 301, stainless steel 302, stainless steel 304, stainless steel 316, stainless steel 405, stainless steel 410, stainless steel 430, stainless steel 442, manganese alloyed steel, cobalt alloys, graphite, silicon carbide, silicon infiltrated silicon carbide, aluminum oxide, tungsten, titanium, cermets, high temperature ceramics, refractory mortars, refractory tiles or bricks, super high curie point piezo electric materials such as the perovskite-like layer structured (PLS) A2B2O7 materials, composite materials made of organic or inorganic resins with or without organic or inorganic fibers, or other materials known to a person of ordinary skill in the art, or a combination thereof, as a solid element, a hollow element or as a multilayered element.

12. The system of claim 3, wherein the heat transfer and storage elements (23) are made of at least two materials including a core material (33) and a shell material (34) located around the core material (33).

13. The system of claim 12, wherein the core material (33) is made of a material with a phase change temperature lower than the material of shell material (34).

14. The system of claim 12, wherein the core material (33) is made of a material that is selected from the group consisting of ceramic materials, cermets, graphite, silicon carbide, silicon infused silicon carbide, aluminum oxide, zirconium, magnesium oxide, or metals such as steel, depleted uranium, titanium, lead, tungsten, paraffin, eutectic salts, lithium compounds or any other material known to a person of ordinary skill in the art, or a combination thereof.

15. The system of claim 3, wherein the heat transfer and storage elements (23) are particles suspended in the fluid (1).

16. The system of claim 3, wherein the heat transfer and storage elements (23) are heated by means of electromagnetic fields, electromagnetic radiation, joule effect, radiant or convective heat or a combination thereof.

17. The system of claim 3, wherein the heat transfer and storage elements (23) are heated by means of electromagnetic fields,
wherein the frequency and shape of the electromagnetic field is tuned for increasing the electromagnetic coupling with the set of heat transfer and storage elements (23) or the structure (22),
wherein the heat transfer and storage elements (23), the structure (22) or both are heated by means of induced eddy and other currents by hysteretic heating or a combination thereof.

18. The system of claim 3, wherein the heat transfer and storage elements (23) are heated by means of electromagnetic radiation created by microwaves heating,
wherein the frequency of the microwaves is tuned to match the resonant frequency of the set of heat transfer and storage elements (23) so that the energy is transferred efficiently to increase the kinetic energy of the molecules, and
wherein the frequency of the microwaves is varied and tuned to exploit modulation to direct the energy and achieve better heating uniformity and speed,
wherein the heat transfer and storage elements (23) are heated by means of dipolar rotation, ionic conduction, absorption of radiation, among other methods of electromagnetic radiation.

19. The system of claim 3, wherein the heating subsystem (10) is cooled by means of a cooling fluid (36), and wherein the cooling fluid (36) allows an electromagnetic heating energy source or an electromagnetic field source to be at a significantly lower temperature than the set of heat transfer and storage elements (23) and the fluid (1), wherein the heat removed by the cooling fluid can be transferred to the fluid (1) by means of a heat exchanger recuperator (91).

20. The system of claim 3, wherein the insulation subsystem (24) comprises at least one insulation layer (37) which comprises a vacuum chamber, or a chamber filled with a low thermal conductivity fluid.

21. The system of claim 3, wherein the set of heat transfer and storage elements (23) is configured to increase its temperature due to the action of a hot fluid;
wherein the energy of the hot fluid is transferred to the set of heat transfer and storage elements (23),
wherein the set of heat transfer and storage elements (23) are colder than the hot fluid, and the set of heat transfer and storage elements (23) increases its temperature as the hot fluid (1) passes through it, and
wherein the energy of the hot fluid is absorbed and stored by the set of heat transfer and storage elements (23).

22. The system of claim 3, wherein the energy supplied by the heating subsystem (10) heats up the set of heat transfer and storage elements (23) and a heat flux (39) transports the energy to the fluid (1), and wherein a closed energy balance between the energy input from the heating subsystem (10), the energy absorbed by the fluid (1) leaving the system (100) and the system (100) energy losses is generated.

23. The system of claim 3, wherein the energy supplied by the heating subsystem (10) heats up the set of heat transfer and storage elements (23), wherein the energy supplied is stored in the set of heat transfer and storage elements (23) for immediate or later use, and wherein a closed energy balance between the energy input from the heating subsystem (10), the energy stored in the set of heat transfer and storage elements (23) and the energy absorbed by the fluid (1) leaving the system (100) and the system (100) energy losses is generated.

24. The system of claim 2, wherein the system (100) is integrated with an industrial process by means of an open loop or a closed loop.

25. The system of claim 2, wherein an energy source (81) to which the heating subsystem (10) is connected is selected from electricity in the form of direct current or alternating current, at any voltage level and at any frequency, in the form of continuous or intermittent power, drawn from the grid or from off-grid electricity sources, wherein the heating subsystem (10) is frequency and voltage independent.

26. The system of claim 1, wherein the electrical feeding subsystem (80) is connected to an off-grid electricity source, source (84), wherein the components required to match the grid frequency are removed and delivering direct current or variable frequency current to the heating subsystem (10).

27. The system of claim 1, wherein the electrical feeding subsystem (80) is connected to the off-grid electricity source (84), wherein frequency of the source (84) is configured in such a way that it matches the frequency required by the heating subsystem (10).

28. The system of claim 3, wherein the fluid (1) heated is post-heated by the post heating subsystem (50) after passing through the set of heat transfer and storage elements (23) by changing the phase of the fluid (1) heated into plasma.

29. The system of claim 1 wherein the fluid (1) is a radiant gas comprising:
polar bonds and/or permanent dipole moments such as H₂O or CO₂;
multiple bonds such as C═O or N≡N, wherein the multiple bonds are double or triple bonds;
polyatomic molecules with a wide range of vibrational and rotational modes such as CH₄ and N₂O;
molecules with resonance structures wherein electrons are delocalized across multiple atoms such as O₃; and
heavy atoms with strong bonds such as SO₂.

30. The system of claim 3, wherein the heat transfer and storage elements (23) are completely or partially coated with one or more catalysts (92) to promote a chemical reaction in the fluid (1).

31. An array (400) for generation, storage and transfer of thermal energy, comprising:
a first system (100);
a second system (200) connected to the first system (100),
wherein the outlet of a first heat transfer and storage subsystem (20) of the first system (100) is configured to be the inlet of the heat transfer and storage subsystem (20) of a second system (200),
wherein a set of heat transfer and storage elements (23) of a heat transfer and storage subsystem (20) of the first system (100) transfers energy to a fluid (1) to approach a target outlet temperature (44) required by an industrial process,
wherein if the temperature of the fluid (1) in the first heat transfer and storage subsystem (20) does not provide enough temperature to reach the target outlet temperature (44), an outlet (42) of the first system (100) is diverted by means of a diverter (43) to a second heat transfer and storage subsystem (20) of the second system (200),
wherein the fluid (1) enters pre-heated by the heat transfer and storage subsystem (20) of the first system (100) to the second heat transfer and storage subsystem (20) in such a way that the fluid (1) is able to reach the target outlet temperature (44) required by the industrial process.

32. The array of claim 31, wherein the first system (100) and the second system (200) are similarly configured to work with systems (500) and are arranged in a configuration in series, parallel or a combination thereof.
